(19) United States
(12) Patent Application Publication
(10) Pub. No.: US 2005/0249069 A1
(43) Pub. Date: Nov. 10, 2005

(54) Disk apparatus and entertainment apparatus

(76) Inventors: Keiichi Aoki, Tokyo (JP); Toshiaki Watanabe, Chiba (JP)

Correspondence Address: KATTEN MUCHIN ROSENMAN LLP, 575 MADISON AVENUE, NEW YORK, NY, 10022-2585, US

(21) Appl. No.: 11/125,835

(22) Filed: May 10, 2005

(30) Foreign Application Priority Data
May 10, 2004 (JP) 2004-140154

(51) Int. Cl. G11B 5/09

(52) U.S. Cl. 369/47.1; 369/53.1

(57) ABSTRACT

A disk apparatus has a main assembly and a casing housing the main assembly therein. The main assembly includes: an actuating unit for rotating a disk for recording information thereon and/or reproducing information therefrom; an information reading/writing unit for reproducing information recorded on the disk which is being rotated by the actuating unit and/or recording information on the disk which is being rotated by the actuating unit; and a control unit for controlling the actuating unit and the information reading/writing unit. The casing includes a main casing body housing therein the actuating unit, the information reading/writing unit, and the control unit, the main casing body having an opening for loading the disk therethrough into the main casing body, and a lid pivotally supported on the main casing body by a shaft for closing the opening. The main assembly includes a first detecting switch disposed closely to the shaft for detecting an opened state of the lid, and a second detecting switch disposed closely to an end of the lid remote from the shaft for detecting an opened state of the lid. The control unit determines whether the lid is opened or closed based on detected signals from the first detecting switch and the second detecting switch.

### BACKGROUND OF THE INVENTION

1. Field of the Invention

The present invention relates to a disk apparatus and an entertainment apparatus which have a main assembly including an actuator unit for rotating a disk for recording information thereon and/or reproducing information therefrom, an information reading/writing unit for reproducing information recorded on the disk which is being rotated and/or recording information on the disk which is being rotated, and a control unit for controlling the actuator unit and the information reading/writing unit, and a casing housing the main assembly therein.

2. Description of Related Art

Heretofore, there have been known optical disk apparatus for reproducing information recorded on optical disks such as CDs, DVDs, or the like, and optical disk apparatus for recording information on and reproducing information from optical disks. These optical disk apparatus operate by applying a light spot from an optical pickup to the information recorded surface of a loaded optical disk and detecting a light beam reflected from the information recorded surface thereby to record information on and reproduce information from the information recorded surface.

One known optical disk apparatus has a storage unit for storing an optical disk therein and a lid for covering an optical disk stored in the storage unit. The optical disk apparatus also has a spindle motor exposed in the storage unit for supporting an optical disk rotatably. The optical disk that is rotated by the spindle motor is covered with the lid for preventing the user from touching the optical disk which is being rotated. The lid thus makes the optical disk apparatus safe in use and allows the optical disk to rotate unobstructedly.

There is known an optical disk apparatus (CD player) having an opening detecting switch for detecting the opening of a lid (upper lid) when the lid is opened. For details, see Japanese Patent Laid-open No. 11-126409 (pages 4 and 5, FIG. 1). In the optical disk apparatus, the opening detecting switch is disposed in contact with the lid such that the opening detecting switch is turned on when the lid is closed and is turned off when the lid is opened. When the opening detecting switch is turned off, it sends an opening detecting signal to a control circuit in the optical disk apparatus, and the control circuit brakes the optical disk against rotation.

For better product quality to be achieved by optical disk apparatus, however, there is a demand for optical disk apparatus having an arrangement that is capable of detecting when the lid is opened more reliably than the optical disk apparatus disclosed in Japanese Patent Laid-open No. 11-126409.

### SUMMARY OF THE INVENTION

It is therefore an object of the present invention to provide a disk apparatus and an entertainment apparatus which are capable of detecting when the lid is opened more reliably.

According to the present invention, there is provided a disk apparatus comprising a main assembly including an actuating unit for rotating a disk for recording information thereon and/or reproducing information therefrom, an information reading/writing unit for reproducing information recorded on the disk which is being rotated by the actuating unit and/or recording information on the disk which is being rotated by the actuating unit, and a control unit for controlling the actuating unit and the information reading/writing unit, and a casing housing the main assembly therein, the casing comprising a main casing body housing therein the actuating unit, the information reading/writing unit, and the control unit, the main casing body having an opening for loading the disk therethrough into the main casing body, and a lid pivotally supported on the main casing body by a shaft for closing the opening, the main assembly including a first detecting switch disposed closely to the shaft for detecting an opened state of the lid, and a second detecting switch disposed closely to an end of the lid remote from the shaft for detecting an opened state of the lid, wherein the control unit determines whether the lid is opened or closed based on detected signals from the first detecting switch and the second detecting switch.

The disk may be an optical disk such as a CD, a CD-ROM, a CD-R, a CD-RW, a DVD-ROM, a DVD−R, a DVD−RW, a DVD+R, a DVD+RW, a DVD-RAM, or a BD (BLU-RAY DISC: registered trademark), an MO disk (magneto-optical disk), a magnetic disk, or a phonographic recording medium, etc.

According to the present invention, the first detecting switch disposed closely to the shaft by which the lid is angularly movably supported and the second detecting switch disposed closely to the end of the lid remote from the shaft detect when the lid is opened. Therefore, the lid is reliably detected as being opened. Specifically, when the lid is opened, even if the second detecting switch, which is positioned closely to the end of the lid that provides a relatively large opening when the lid is opened, is artificially pressed by the user and detects the lid in error as being closed, the first detecting switch detects the lid as being opened. Since the control unit determines whether the lid is opened or closed based on detected signals from the first detecting switch and the second detecting switch, the lid can reliably be detected as being opened when it is opened.

### BRIEF DESCRIPTION OF THE DRAWINGS

FIG. 1 is a perspective view of an entertainment apparatus according to an embodiment of the present invention;

FIG. 2 is a perspective view of the entertainment apparatus according to the embodiment, illustrating a lid opened from the closed position in FIG. 1;

FIG. 3 is a side elevational view showing the manner in which the lid engages detecting switches when the lid is closed;

FIG. 4 is a side elevational view showing the manner in which the lid engages one of the detecting switches when the lid is slightly opened;

FIG. 5 is a side elevational view showing the manner in which the lid disengages from the detecting switches when the lid is fully opened;

FIG. 6 is a block diagram of a controller for controlling a spindle motor when the lid is opened;

FIG. 7 is a flowchart of a processing sequence of the controller; and

FIG. 8 is a side elevational view showing a modified layout of detecting switches.

### DETAILED DESCRIPTION OF THE PREFERRED EMBODIMENTS

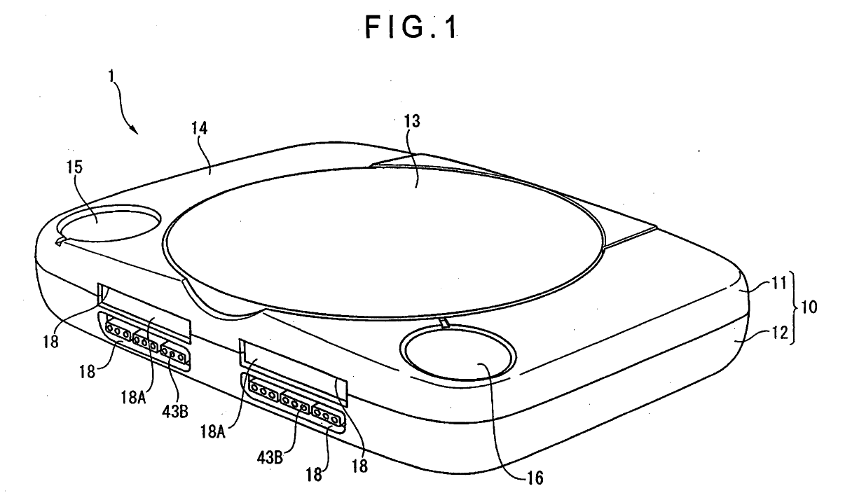

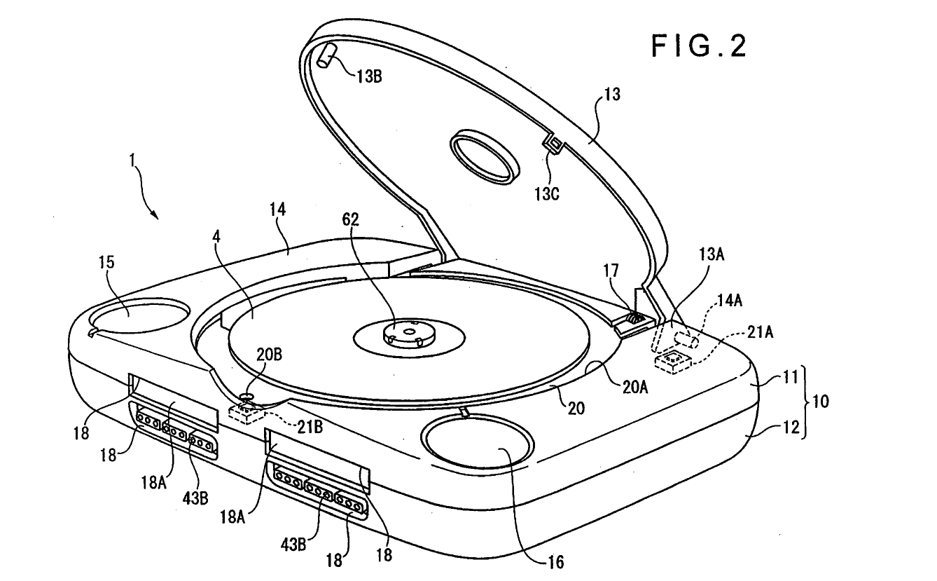

FIG. 1 shows in perspective an entertainment apparatus 1 according to an embodiment of the present invention, and FIG. 2 shows in perspective the entertainment apparatus 1, illustrating a lid opened from the closed position in FIG. 1.

The entertainment apparatus 1 is a disk apparatus for reading a game program recorded on an optical disk 4 such as a CD, a DVD, or the like with a disk drive incorporated in the disk apparatus, and executing the game program depending on commands from a controller (not shown) that is operated by the user (game player). The entertainment apparatus 1 is electrically connected to a television receiver (not shown) and outputs image information and sound information from processed results of the game program.

The execution of a game refers mainly to the control of the progress of the game and the outputting of image information and sound information from the game.

As shown in FIGS. 1 and 2, the entertainment apparatus 1 comprises a main assembly (not shown) having electronic parts and an entertainment apparatus casing (hereinafter referred to as “casing”) 10 housing the main assembly therein.

The casing 10 is made of ABS resin and has an upper case 11 and a lower case 12 which house the main assembly therein. The casing 10 is of a rectangular shape as viewed in plan.

The upper case 11 covers the main assembly from above, and comprises an upper case body 14 serving as a main casing body thereof and a lid 13 disposed substantially centrally in the upper case body 14. The lid 13 is of a substantially circular shape as viewed in plan.

The entertainment apparatus 1 has an optical disk storage unit 20 defined substantially centrally in the upper case body 14. The optical disk storage unit 20 is of a substantially circular shape as viewed in plan and has a substantially concave cross-sectional shape.

The optical disk storage unit 20 has an upwardly open cavity 20A for storing the optical disk 4 therein. The cavity 20A is normally covered with the lid 13.

The upper case body 14 has a hole 20B defined therethrough at a front position in the optical disk storage unit 20 as shown in FIG. 2. A detecting switch 21B is disposed beneath the hole 20B. The detecting switch 21B will be described in detail later on.

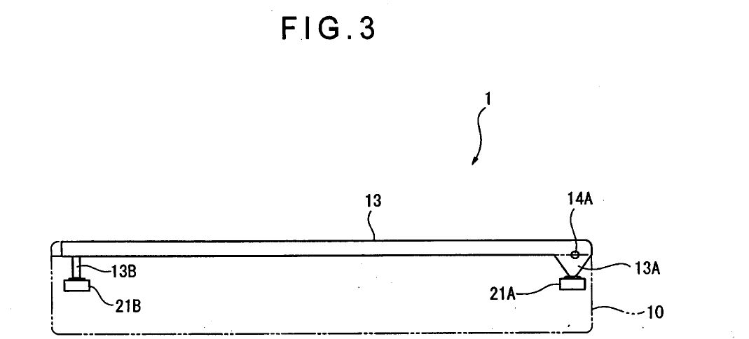

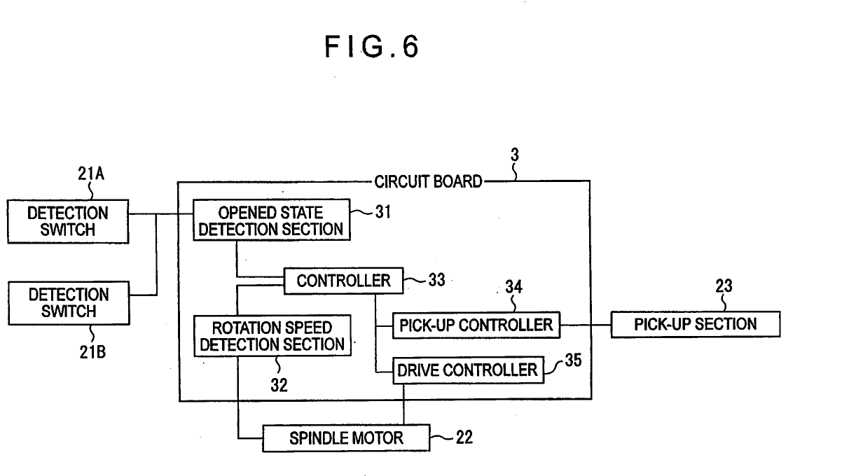

The optical disk storage unit 20 has a chucking member 62 for holding the optical disk 4 therein, the chucking member 62 being disposed substantially centrally in the optical disk storage unit 20. The chucking member 62 is supported on the shaft of a spindle motor (not shown in FIGS. 2 and 3, but shown in FIG. 6) as an actuator unit in the main assembly. The optical disk 4 held in the optical disk storage unit 20 can be rotated by the spindle motor.

In the optical disk storage unit 20, there is exposed an optical pickup (not shown in FIGS. 1 and 2) as an information reading/writing unit for acquiring information recorded on the optical disk 4 and writing information on the optical disk 4 when the optical disk 4 is mounted on the chucking member 62. The optical pickup has an optical head for applying a light spot to the optical disk 4. The optical pickup is electrically connected to a circuit board (not shown in FIGS. 1 and 2) that is disposed in the main assembly for controlling operation of the main assembly. Information acquired by the optical pickup is output to the circuit board and executed and processed by the circuit board.

The upper case body 14 has two openings defined in its upper panel one on each side of the optical disk storage unit 20, and buttons 15, 16 are exposed respectively in these openings. The button 15, which is positioned on the left-hand side of the optical disk storage unit 20, is a power supply button that is manually operated to turn on and off the power supply of the entertainment apparatus 10. The button 16, which is positioned on the right-hand side of the optical disk storage unit 20, is an opening/closing button including an engaging member (not shown) movable into and out of engagement with the lid 13 for opening and closing the lid 13.

A shaft 14A for allowing the lid 13 to be turned when the lid 13 is opened and closed is disposed in the upper case body 14 at a rear position therein as shown in FIG. 2. The shaft 14A holds the lid 13 so as to make the lid 13 angularly movable in an angular range from 0 to 60° with respect to the plane of the optical disk storage unit 20.

The lid 13 is of a substantially circular shape as viewed in plan complementarily to the optical disk storage unit 20 defined in the upper case body 14. The lid 13 has protrusions 13A, 13B and an engaging member 13A formed integrally therewith.

The protrusion 13A is of a substantially triangular shape as viewed in side elevation, and projects as a pointed member downwardly from a rear end of the lid 13. The shaft 14A is mounted on the protrusion 13A and supports the lid 13 angularly movably on the upper case body 14. Specifically, the protrusion 13A has a hole defined therethrough, and the shaft 14A extends through the hole in the protrusion 13A to allow the lid 13 to be angularly moved vertically about the shaft 14A for thereby opening and closing the optical disk storage unit 20. The protrusion 13A has its lower pointed end rounded.

A helical spring 17 is disposed around the shaft 14A between the lid 13 and the upper case body 14 near the protrusion 13A. The lid 13 is opened and closed with respect to the optical disk storage unit 20 under the bias of the helical spring 17.

The protrusion 13B projects downwardly from another end of the lid 13 opposite to the protrusion 13A, i.e., a front end of the lid 13. When the lid 13 is closed, the protrusion 13B is inserted in the hole 20B defined in the optical disk storage unit 20.

The engaging member 13C projects downwardly toward the optical disk storage unit 20 from an outer edge of the lid 13 which is positionally aligned with the engaging member (not shown) formed on the upper case body 14. The engaging member 13C has an opening defined therein. When the lid 13 is closed, the engaging member of the opening/closing button 16 is inserted in the opening of the engaging member 13C, locking the lid 13.

The lid 13 thus constructed is opened as follows:

When the user presses the opening/closing button 16 while the lid 13 is being closed as shown in FIG. 1, the engaging member thereof disengages from the engaging member 13C on the lid 13, and the lid 13 is opened as shown in FIG. 2 under the bias of the helical spring 17. When the lid 13 is thus opened, the optical disk storage unit 20 is exposed. The user places the optical disk 4 through the opening 20A of the optical disk storage unit 20 onto the chucking member 62 that is positioned substantially centrally in the optical disk storage unit 20, and then closes the lid 13. Thereafter, the user presses the power supply button 15 to turn on the power supply of the entertainment apparatus 10 for reproducing information recorded on the optical disk 4.

The casing 10 has four openings 18 defined in a front panel thereof as shown in FIGS. 1 and 2. The openings 18 include an upper array of two laterally spaced openings 18 and a lower array of two laterally spaced openings 18. Memory card connectors (not shown) mounted on the circuit board for controlling operation of the main assembly are exposed in the two openings 18 in the upper array, and controller connectors 43B mounted on the circuit board are exposed in the two openings 18 in the lower array.

The upper two openings 18 are normally closed by shutters 18A, respectively. When the tip ends of memory cards are inserted into the upper two openings 18, the shutters 18A are opened to allow the memory cards to be connected to the memory card connectors in the upper two openings 18.

The casing 10 also has, defined in a rear panel thereof opposite to the front panel, an opening in which there is exposed a power supply connector for supplying electric power to the main assembly through a power supply cable from an external power supply, and an opening in which there are exposed video and audio output terminals for outputting various signals such as video and audio signals recorded on the optical disk 4 to the television receiver.

The casing 10 houses therein detecting switches 21A, 21B as lid opening detectors for detecting when the lid 13 is opened. The detecting switches 21A, 21B comprise pushbutton switches, and are turned off when a certain pressure is applied thereto and turned on when the applied pressure is removed.

The detecting switch 21A, which corresponds to a first detecting switch, is disposed beneath the protrusion 13A of the lid 13. When the lid 13 is closed, the detecting switch 21A is pressed by the pointed end of the protrusion 13A.

The detecting switch 21B, which corresponds to a second detecting switch, is disposed beneath the hole 20B defined in the optical disk storage unit 20. Specifically, the detecting switch 21B is positioned substantially diametrically opposite to the detecting switch 21A near the protrusion 13A across the center of the optical disk storage unit 20. The detecting switch 21B is pressed by the protrusion 13B of the lid 13 when the lid 13 is closed.

The detecting switches 21A, 21B are electrically connected to an opening detector 31 (see FIG. 6) on a circuit board 3 (see FIG. 6) to be described later on. The detecting switches 21A, 21B output electric signals to the opening detector 31 depending on how the detecting switches 21A, 21B are pressed by the respective protrusions 13A, 13B of the lid 13.

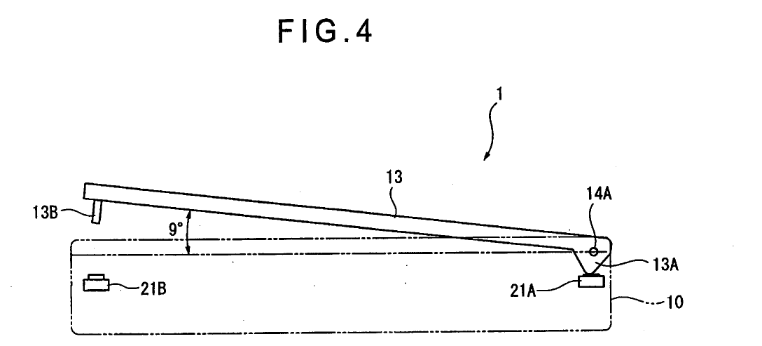

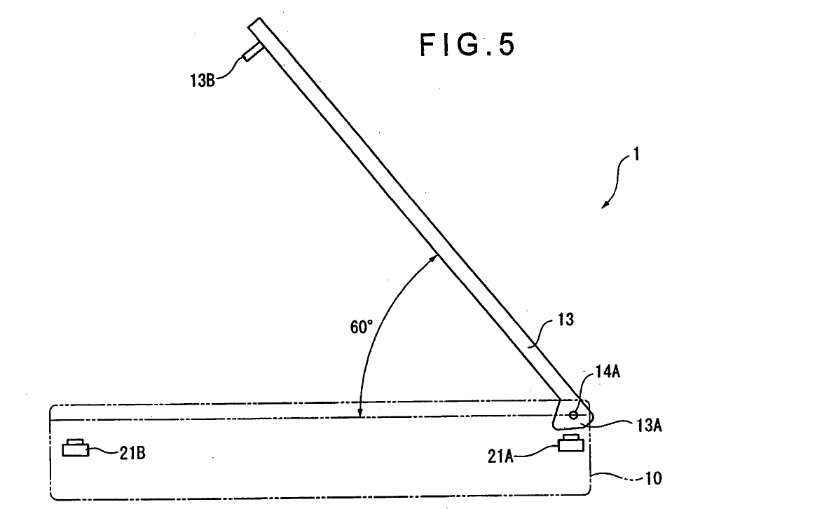

FIGS. 3 through 5 show in side elevation how the lid 13 engages the detecting switches 21A, 21B when the lid 13 is opened and closed. Specifically, FIG. 3 shows the manner in which the lid 13 engages the detecting switches 21A, 21B when the lid 13 is closed, FIG. 4 the manner in which the lid 13 engages the detecting switch 21A when the lid 13 is slightly opened, and FIG. 5 the manner in which the lid 13 disengages from the detecting switches 2LA, 21B when the lid 13 is fully opened.

When the lid 13 is closed, as shown in FIG. 3, the detecting switches 21A, 21B are pressed by the pointed ends of the respective protrusions 13A, 13B of the lid 13, and hence are turned off. When the power supply of the entertainment apparatus 1 is turned on, a power supply unit (not shown) applies a voltage to the detecting switches 21A, 21B. The detecting switches 21A, 21B output an electric signal indicating that the detecting switches 21A, 21B are turned off to the opening detector 31 on the circuit board 3. Alternatively, the detecting switches 21A, 21B may be arranged such that they do not output an electric signal to the opening detector 31 when the detecting switches 21A, 21B are turned off.

When the lid 13 is slightly opened, i.e., when the lid 13 is opened through an angle ranging from 1 to 10°, as shown in FIG. 4, the detecting switch 21A remains pressed by the protrusion 13A of the lid 13, but the detecting switch 21B is released from the protrusion 13B of the lid 13 as the protrusion 13B is spaced and disengages from the detecting switch 21B. At this time, the detecting switch 21A outputs an electric signal indicating that the detecting switch 21A is turned off to the opening detector 31, and the detecting switch 21B outputs an electric signal indicating that the detecting switch 21B is turned on to the opening detector 31 because the protrusion 13B disengages from the detecting switch 21B.

When the lid 13 is fully opened, i.e., when the lid 13 is opened through an angle ranging from 11 to 60°, the detecting switches 21A, 21B are released from the protrusions 13A, 13B of the lid 13 as the protrusions 13A, 13B are spaced and disengage from the detecting switches 21A, 21B. At this time, the detecting switches 21A, 21b output an electric signal indicating that the detecting switches 21A, 21B are turned on to the opening detector 31.

FIG. 6 shows in block form a controller for controlling the spindle motor 22 and the optical pickup 23 based on the electric signals from the detecting switches 21A, 21B.

The circuit board 3 serves to control operation of the entertainment apparatus 1. The circuit board 3 supports thereon electronic components such as a CPU (Central Processing Unit) for processing programs read from the optical disk 4, and a memory for temporarily storing the programs processed by the CPU. The electronic components supported on the circuit board 3 also include the opening detector 31 for outputting an electric signal based on the open/closed state of the lid 13, a rotational speed detector 32 for detecting the rotational speed of the spindle motor 22, and a controller 33 as a control unit for controlling the spindle motor 22 and the optical pickup 23 through a pickup controller 34 and a motor controller 35 based on the electric signals output from the opening detector 31 and the rotational speed detector 32.

The opening detector 31 is electrically connected to the detecting switches 21A, 21B. The opening detector 31 is supplied with electric signals that are output from the detecting switches 21A, 21B depending on how the detecting switches 21A, 21B are pressed by the respective protrusions 13A, 13B of the lid 13. When the opening detector 31 is supplied with an electric signal indicating that either one of the detecting switches 21A, 21B is turned on, i.e., either one of the protrusions 13A, 13B of the lid 13 disengages from the corresponding one of the detecting switches 21A, 21B, the opening detector 31 outputs an electric signal indicating that the lid 13 is opened and either one of the detecting switches 21A, 21B is turned on, to the controller 33.

The rotational speed detector 32 is connected to the spindle motor 22 for detecting the rotational speed of the spindle motor 22. The rotational speed detector 32 outputs an electric signal indicative of the detected rotational speed of the spindle motor 22 to the controller 33.

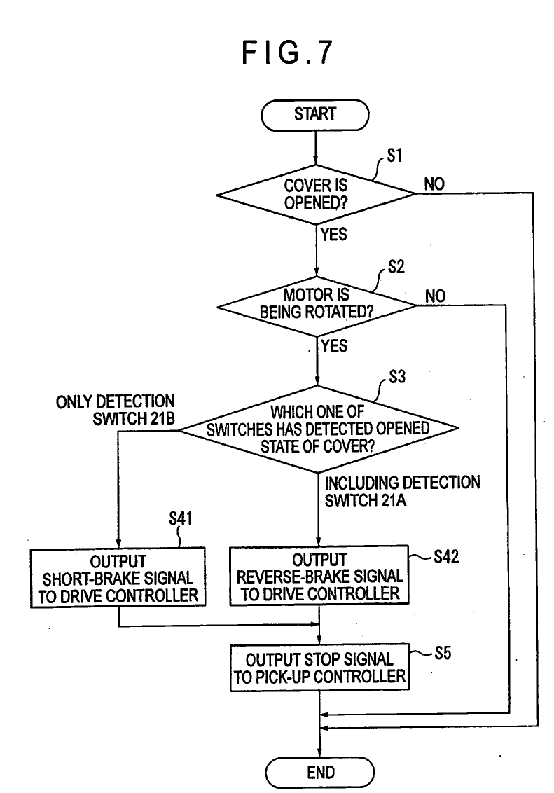

FIG. 7 shows a processing sequence of the controller 33.

Based on the electric signals output from the opening detector 31 and the rotational speed detector 32, the controller 33 outputs drive signals to the pickup controller 34 which moves the optical pickup 23 and controls the application of a light spot from the optical head to the optical disk 4, and the motor controller 35 which controls operation of the spindle motor 22.

As shown in FIG. 7, the controller 33 determines whether the lid 13 is opened or not based on the electric signal from the opening detector 31 in step S1. If the electric signal from the opening detector 31 indicates that the lid 13 is not opened, then the processing sequence shown in FIG. 7 is put to an end.

If the electric signal from the opening detector 31 indicates that the lid 13 is opened, then the controller 33 determines whether the spindle motor 22 is rotating or not based on the electric signal from the rotational speed detector 32 in step S2. If the electric signal from the rotational speed detector 32 indicates that the spindle motor 22 is not rotating, then the processing sequence is put to an end.

If the electric signal from the rotational speed detector 32 indicates that the spindle motor 22 is rotating, then the controller 33 determines which of the detecting switches 21A, 21B has detected the opening of the lid 13, i.e., which of the detecting switches 21A, 21B has changed from the OFF state to the ON state, in step S3.

If only the detecting switch 21B outputs an electric signal indicating that it is turned on, i.e., if the lid 13 is opened through an angle ranging from 1° to 9°, then the controller 33 outputs a short-circuit brake signal to the motor controller 35 to apply short-circuit braking to the spindle motor 22 in step S41. In response to the short-circuit brake signal, the motor controller 35 stops supplying electric energy to the spindle motor 22 and provides a short circuit on an electric current regenerated by the spindle motor 22, thereby applying short-circuit braking to the spindle motor 22. The spindle motor 22 is now gradually braked. If the user closes the lid 13 while the spindle motor 22 is being gradually braked, then the spindle motor 22 can quickly be rotated back to the desired rotational speed, thus minimizing any idle time in which the user needs to wait for the game to be resumed.

If at least the detecting switch 21A outputs an electric signal indicating that it is turned on, i.e., if the lid 13 is opened through an angle ranging from 10° to 60°, then the controller 33 outputs a reverse brake signal to the motor controller 35 to apply reverse braking to the spindle motor 22 in step S42. In response to the reverse brake signal, the motor controller 35 forcibly supplies a reverse current to the spindle motor 22 to apply reverse braking to the spindle motor 22. When the lid 13 is widely opened, therefore, the spindle motor 22 is quickly stopped against rotation. Thus, the spindle motor 22 is prevented from damage if the optical disk 4 is artificially and forcibly braked against rotation. In addition, the optical disk 4 is prevented from jumping out of the optical disk storage unit 20 under centrifugal forces when the optical disk storage unit 20 is opened by the lid 13.

After step S41 or S42, the controller 33 outputs a drive signal for retracting the optical pickup 23 to a safe position and also a signal for stopping the application of the light spot from the optical head to the optical disk 4, to the pickup controller 34 in step S5. In response to these signals, the pickup controller 34 moves the optical pickup 23 to the retracted position, e.g., a position corresponding to an innermost area of the optical disk 4, and stops applying the light spot emitted from the optical head to the optical disk 4 for reading information from and recording information on the optical disk 4.

Steps S3, S41, S42, and step S5 may be switched around in their order. If the power supply of the entertainment apparatus 1 is turned on, step S1 is always executed. If the electric signal from the opening detector 31 indicates that the lid 13 is opened, then step S2 is executed preferentially as an interrupt process during the execution of the game program.

The entertainment apparatus 1 according to the present embodiment offers the following advantages:

The detecting switches 21A, 21B for detecting when the lid 13 is opened are disposed in the casing 10 so as to contact the respective protrusions 13A, 13B of the lid 13 when the lid 13 is closed. When the protrusion 13A disengages from the detecting switch 21A, the detecting switch 21A outputs an electric signal indicating that it is turned on, i.e., the lid 13 is opened, to the opening detector 31 on the circuit board 3. When the protrusion 13B disengages from the detecting switch 21B, the detecting switch 21B outputs an electric signal indicating that it is turned on, i.e., the lid 13 is opened, to the opening detector 31 on the circuit board 3. Even if the lid 13 is opened and the user presses the detecting switch 21B, since the detecting switch 21A detects when the lid 13 is opened, the lid 13 can reliably be detected as being opened.

Based on the electric signals output from the detecting switches 21A, 21B, the opening detector 31 outputs an electric signal indicating whether the lid 13 is opened or closed to the controller 33. If the lid 13 is opened and the optical disk 4 is rotating, then the controller 33 brakes the optical disk 4 against rotation. The spindle motor 22 is thus reliably braked as the lid 13 is opened, preventing the optical disk 4 and the circuit board 3 from being damaged.

The lid 13 can be opened through an angle ranging from 0 to 60° with respect to the plane of the optical disk storage unit 20. The detecting switch 21A detects when the lid 13 is opened through the angle ranging from 10° to 60°, and the detecting switch 21B detects when the lid 13 is opened through the angle ranging from 1° to 60°. If it is assumed that the optical disk 4 is about 12 cm across, as with CDs, and the lid 13 is of about the same size as the optical disk 4, then when the lid 13 is opened through 9°, which is the maximum angle of the lid 13 that is detected by only the detecting switch 13B, a gap of about 1.9 cm at maximum is created between the distal end of the lid 13 and the optical disk storage unit 20. Since the gap is just large enough to put a user's finger therethrough, it is difficult for the user to insert the finger through the gap into the optical disk storage unit 20 and apply the finger to press the detecting switch 21B. Therefore, when the lid 13 is opened through 9°, the user is unable to artificially press the detecting switch 12B, and hence the lid 13 is prevented from being detected in error as being closed. For forcibly inserting a finger deeply through the gap into the optical disk storage unit 20, the lid 13 needs to be opened more widely to increase the gap. At this time, however, the detecting switch 21A detects the lid 13 as being opened even if the detecting switch 21b is artificially pressed. The lid 13 can thus be detected as being opened highly reliably.

The detecting switches 21A, 21B comprise pushbutton switches, respectively. The detecting switch 21A is disposed in a position where it is pressed by the pointed end of the protrusion 13A of the lid 13 when the lid 13 is closed, and the detecting switch 21B is disposed in a position where it is pressed by the pointed end of the protrusion 13B of the lid 13 when the lid 13 is closed. When the lid 13 is angularly moved about the shaft 14A, the detecting switch 21A changes between the pressed and non-pressed states and hence between the OFF and ON states, and the detecting switch 21B also changes between the pressed and non-pressed states and hence between the OFF and ON states. The lid 13 can thus be detected as being opened and closed reliably by a simple arrangement.

The opening detector 31 detects when the lid 13 is opened and closed based on electric signals that are output from the detecting switches 21A, 21B. The rotational speed detector 32 detects the rotational speed of the spindle motor 22. Detected signals from the opening detector 31 and the rotational speed detector 32 are output to the controller 33. When the lid 13 is opened and the spindle motor 22 is rotating, the controller 33 outputs a drive signal for braking the spindle motor 22 to the motor controller 35, and also outputs a control signal for controlling the optical pickup 23 to the pickup controller 34. Since the spindle motor 22 being rotated can be braked as the lid 13 is opened, the optical disk 4 is prevented from disengaging from the spindle motor 22 and jumping out of the optical disk storage unit 20 under centrifugal forces which would be applied to the optical disk 4 by the rotation of the optical disk 4. Inasmuch as the user is prevented from artificially braking the spindle motor 22, the electric components on the circuit board 3 are prevented from being electrically damaged, and the parts of the entertainment apparatus 1 are also prevented from being damaged under undue loads. When the lid 13 is opened, the optical pickup 23 is displaced into the retracted position, and stops applying the light spot to the optical disk 4. Accordingly, the optical pickup 23 is prevented from being damaged when the lid 13 is opened.

When only the detecting switch 21B detects the lid 13 as being opened, the controller 33 outputs a short circuit brake signal to the motor controller 35 to apply short-circuit braking to the spindle motor 22. When the detecting switch 21A detects the lid 13 as being opened, the controller 33 outputs a reverse brake signal to the motor controller 35 to apply reverse braking to the spindle motor 22. When short-circuit braking is applied to the spindle motor 22, the rotational speed of the optical disk 4 is gradually lowered. Therefore, if the lid 13 is slightly opened and then closed, the spindle motor 22 can quickly be rotated back to the desired rotational speed. When reverse braking is applied to the spindle motor 22, the optical disk 4 is quickly stopped against rotation.

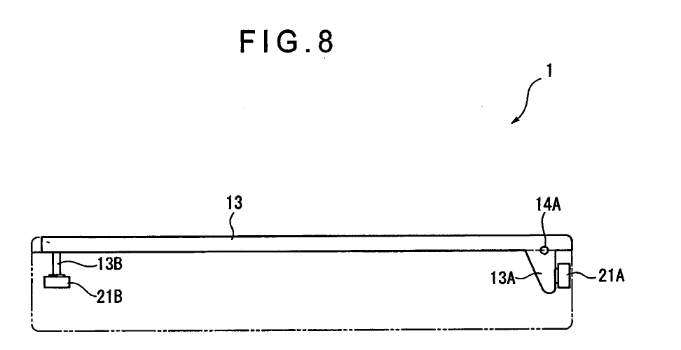

In the above embodiment, the detecting switch 21A is disposed beneath the protrusion 13A of the lid 13. FIG. 8 shows a modification in which the detecting switch 21A is disposed on an inner side surface of the casing 10. That is, the detecting switch 21A may be disposed in a position where it is pressed by the protrusion 13A when the lid 13 is closed and it is released from the protrusion 13A when the lid 13 is opened. However, if the detecting switch 21A is disposed beneath the protrusion 13A so that it is pressed by the pointed end of the protrusion 13A, then the protrusion 13A can reliably be brought into pressing contact with the detecting switch 21A even if the lid 13 wobbles in its movement.

In the above embodiment, the detecting switches 21A, 21B comprise pushbutton switches, respectively. However, the detecting switches 21A, 21B may comprise slide switches or optical switches. The detecting switches may not be ON-OFF switches, but may be of the type in which the resistance thereof increases or decreases depending on the pressure applied to the switch, and the lid 13 is detected as being opened or closed depending on the magnitude of an electric current flowing through the switch.

In the above embodiment, the detecting switches 2LA, 21B are turned off when pressed respectively by the protrusions 13A, 13B of the lid 13 and turned on when released therefrom. However, the detecting switches may be arranged such that they are turned on when pressed respectively by the protrusions 13A, 13B of the lid 13 and turned off when released therefrom.

In the above embodiment, the spindle motor 22 for rotating the optical disk 4 is braked by short-circuit braking or reverse braking based on how the lid 13 is opened or closed. However, the spindle 22 may be braked by short-circuit braking or reverse braking when the lid 13 is released from either one of the detecting switches 21A, 21B and hence is detected as being opened.

In the above embodiment, the detecting switch 21A detects the lid 13 as being opened when the lid 13 is angularly moved through the angle ranging from 10° to 60°, and the detecting switch 21B detects the lid 13 as being opened when the lid 13 is angularly moved through the angle ranging from 1° to 60°. However, the angular ranges in which the lid 13 is detected as being opened are not limited to those angular ranges. Specifically, the angular ranges in which the lid 13 is detected as being opened may be increased by changing the positions and configurations of the detecting switches 21A, 21B in the form of pushbutton switches.

The angular range in which the lid 13 is detected as being opened by the detecting switch 21B is not limited to the range from 1° to 60°, but may be smaller or larger than 60°.

The principles of the present invention are applicable to a disk apparatus for reproducing information recorded on and/or recording information on a disk such as an optical disk, e.g., a CD, a DVD, or the like, a magneto-optical disk, a magnetic disk, or a phonographic recording medium, etc.

Although certain preferred embodiments of the present invention have been shown and described in detail, it should be understood that various changes and modifications may be made therein without departing from the scope of the appended claims. According to the present embodiment, the first detecting switch disposed closely to the shaft by which the lid is angularly movably supported and the second detecting switch disposed closely to the end of the lid remote from the shaft detect when the lid is opened. Therefore, the lid is reliably detected as being opened. Specifically, when the lid is opened, even if the second detecting switch, which is positioned closely to the end of the lid that provides a relatively large opening when the lid is opened, is artificially pressed by the user and detects the lid in error as being closed, the first detecting switch detects the lid as being opened. Since the control unit determines whether the lid is opened or closed based on detected signals from the first detecting switch and the second detecting switch, the lid can reliably be detected as being opened when it is opened. Preferably, the lid is openable through an angle of about 60°, the first detecting switch detects when the lid is opened through an angular range from about 10° to 60°, and the second detecting switch detects when the lid is opened through an angular range from about 1° to 60°.

The lid may be detected in error as being closed when a finger of the user touches the second detecting switch that is located closely to the end of the lid remote from the shaft, i.e., the end of the lid which moves largely when the lid is opened. If the lid has a size similar to a CD having a diameter of about 12 cm, then the lid is opened through an angle of about 10° or more for a finger to be inserted between the lid and the opening for loading the disk therethrough. According to the present invention, even when the second detecting switch detects the lid as being closed, if the lid is opened through the angle of 10° or more, the first detecting switch detects the lid as being opened. Since the first detecting switch detects when the lid is opened through an angle ranging from about 10° to 60°, even when the second detecting switch detects the lid as being closed for some reasons, the first detecting switch reliably detects the lid as being opened.

Preferably, the first detecting switch comprises a pushbutton switch, the lid having a protrusion disposed closely to the shaft and angularly movable in unison with the lid for pressing the first detecting switch when the lid is closed.

Inasmuch as the first detecting switch in the form of a pushbutton switch is pressed by the protrusion that is angularly moved in unison with the lid, an opened state of the lid is reliably detected by the first detecting switch. As an opened state of the lid is reliably detected by the first detecting switch when it is pressed by the protrusion, the detection by the first detecting switch of an opened state of the lid is performed by a simple arrangement.

Preferably, the second detecting switch comprises a pushbutton switch disposed in a position aligned with a hole defined in the main casing body, the lid having a protrusion for pressing the second detecting switch through the hole when the lid is closed.

As with the first detecting switch, the second detecting switch comprises a pushbutton switch and is pressed by the protrusion of the lid. Therefore, the detection by the second detecting switch of an opened state of the lid is performed by a simple arrangement. Because the second detecting switch is disposed in a position aligned with a hole defined in the main casing body, the protrusion of the lid presses the second detecting switch through the hole when the lid is closed. Accordingly, the opened state of the lid can be detected by the second detecting switch in combination with a simple error-free mechanism including the protrusion and the hole.

Preferably, the control unit controls the actuating unit to brake the disk against rotation when either one of the first detecting switch and the second detecting switch detects the lid as being opened. Stated otherwise, the control unit should preferably judge that the lid is closed when both the first detecting switch and the second detecting switch detect the lid as being closed.

According to the present invention, inasmuch as the control unit controls the actuating unit to brake the disk against rotation when either one of the first detecting switch and the second detecting switch detects the lid as being opened, centrifugal forces acting on the disk are reduced when the lid is opened while the disk is in rotation. As the engagement between the disk and the actuating unit is not weakened when the disk is braked, the disk is stably held in the main casing body. Furthermore, since the disk as it is rotating does not need to be artificially stopped for the removal of the disk, the disk apparatus is highly convenient to use, and the actuating unit for rotating the disk is stable in operation.

According to the present invention, there is also provided an entertainment apparatus incorporating the disk apparatus described above.

The entertainment apparatus may be an apparatus for executing various programs such as game programs or the like as instructed by the user, or reproducing recorded video and audio information.

The entertainment apparatus offers substantially the same advantages as those of the disk apparatus described above. Specifically, when a disk serving as an information source for the entertainment apparatus is loaded or ejected, the lid of the disk apparatus incorporated in the entertainment apparatus can reliably be detected as being opened or closed. Accordingly, the entertainment apparatus has high product quality.

The above and other objects, features, and advantages of the present invention will become apparent from the following description when taken in conjunction with the accompanying drawings which illustrate preferred embodiments of the present invention by way of example.

The priority application Number JP2004-140154 upon which this patent application is based is hereby incorporated by reference.

1. A disk apparatus comprising:
a main assembly including an actuating unit for rotating a disk for recording information thereon and/or reproducing information therefrom, an information reading/writing unit for reproducing information recorded on the disk which is being rotated by said actuating unit and/or recording information on the disk which is being rotated by said actuating unit, and a control unit for controlling said actuating unit and said information reading/writing unit; and
a casing housing said main assembly therein;
said casing comprising a main casing body housing therein said actuating unit, said information reading/writing unit, and said control unit, said main casing body having an opening for loading the disk therethrough into said main casing body, and a lid pivotally supported on said main casing body by a shaft for closing said opening;
said main assembly including a first detecting switch disposed closely to said shaft for detecting an opened state of said lid, and a second detecting switch disposed closely to an end of said lid remote from said shaft for detecting an opened state of said lid;
wherein said control unit determines whether said lid is opened or closed based on detected signals from said first detecting switch and said second detecting switch.

2. The disk apparatus according to claim 1, wherein said lid is openable through an angle of about 60°, said first detecting switch detects when said lid is opened through an angular range from about 10° to 60°, and said second detecting switch detects when said lid is opened through an angular range from about 1° to 60°.

3. The disk apparatus according to claim 1, wherein said first detecting switch comprises a pushbutton switch, said lid having a protrusion disposed closely to said shaft and angularly movable in unison with said lid for pressing said first detecting switch when said lid is closed.

4. The disk apparatus according to claim 1, wherein said second detecting switch comprises a pushbutton switch disposed in a position aligned with a hole defined in said main casing body, said lid having a protrusion for pressing said second detecting switch through said hole when said lid is closed.

5. The disk apparatus according to claim 1, wherein said control unit controls said actuating unit to brake said disk against rotation when either one of said first detecting switch and said second detecting switch detects said lid as being opened.

6. An entertainment apparatus incorporating a disk apparatus according to claim 1.
